(19) United States
(12) Patent Application Publication
(10) Pub. No.: US 2006/0252019 A1
(43) Pub. Date: Nov. 9, 2006

(54) Knot tying training apparatus

(76) Inventors: David Burkitt, Olton (GB); Miles Kitching, Westbury-on-Trym (GB)

Correspondence Address: Patula & Associates, P.C.;14th Floor, 116 S. Michigan Ave., Chicago, IL, 60603, US

(21) Appl. No.: 11/123,890

(22) Filed: May 6, 2005

(51) Int. Cl. G09B 23/28; G09B 19/24

(52) U.S. Cl. 434/262; 434/260

(57) ABSTRACT

A knot tying training apparatus (2) comprising at least one knot tying element (4a, 4b) around which a knot may be tied in use of the apparatus (2), one or more sensing devices (10, 16) associated with the or each knot tying element (4a, 4b) for generating a signal in response to a knot being tied around the or each knot tying element (4a, 4b) and a feedback presentation device (220) in communication with the one or more sensing devices (10, 16) for providing feedback to a user.

Foreign priority benefits of United Kingdom Patent Application No. 0410322.2, filed May 8, 2004, are claimed.

The present invention relates to knot tying training apparatus.

### BACKGROUND OF THE INVENTION

Knot tying is an essential skill for all healthcare professionals performing surgery. Many surgical procedures require wounds to be sutured or vessels to be ligated (tied off). However, these skills are becoming increasing difficult to teach as students receive less time in theatre.

A number of training aids are available which allow students and surgeons alike to practice their skills. One such aid is the “Knot Tying Trainer” made by Limbs & Things Limited, a United Kingdom company. This product comprises a plurality of knot tying elements around which a user may practice tying knots. In addition, the product is provided with transparent cylinders which may be placed around the knot tying elements to limit access and thus provide a more accurate simulation of the techniques required.

Products such as the “Knot Tying Trainer” provide useful training tools for students and surgeons. However, it can be difficult for a teacher to determine whether the student has used the appropriate force when tying the knot. There are three main elements which are important in the tying of a surgical knot.

Firstly, during the process of tying the knot, the amount of pull away from the target area should be minimal. Any such pull can result in damage to the target area in which the knot is being tied.

Secondly, the tension of the knot needs to be appropriate for its particular purpose. For example, a suture in the abdominal region, which is relatively tough, would require a greater tension than is required in ligating a delicate vessel. In any event, if the knot is tied too tightly there is a danger that the target area will be damaged.

The third key element is quality and structure of the completed knot. The tied knot must hold fast and not slip over time.

Using conventional training aids it is only possible to examine the first two elements to a limited degree. The third aspect can be assessed by visual observation and by putting the knot under tension, either manually or mechanically. Consequently, there is a need for a knot tying training apparatus which provides improved means for teaching and assessing the skills of students.

### SUMMARY OF THE INVENTION

According to the present invention there is provided a knot tying training apparatus comprising:

at least one knot tying element around which a knot may be tied in use of the apparatus;

sensing means associated with the or each knot tying element for generating a signal in response to a knot being tied around the or each knot tying element; and

feedback presentation means in communication with the sensing means for providing feedback to a user.

The apparatus is particularly intended to be used as a clinical, medical and/or surgical skills assessment apparatus. The knot tying apparatus has the advantage over existing knot tying training products in that it provides feedback to the user about the knot tying process and the quality of the knot. The feedback may be generated during and/or after the knot tying process such that the student may be guided during the process and an assessor may view the feedback at a later date. Preferably, the or each knot tying element is movable about a fixed point and more preferably the or each knot tying element is rotatable about the fixed point. When this is the case the sensing means preferably generates a signal corresponding to the displacement of the or each knot tying element from a rest position. This enables the first of the three key knot tying elements to be assessed.

In addition, the apparatus may conveniently be provided with force adjustment means for adjusting the force required to move the or each knot tying element from the rest position. Dampening means such as this enables the force required to move the or each knot tying element to be varied. This will allow the apparatus to be calibrated for users of different skill levels. A skilled surgeon should be able to tie a knot in a confined space without exerting any pulling forces on the target area. However, a student learning their skills will undoubtedly cause the target to be pulled, pushed and lifted during the process of tying a knot. By adjusting the force required to move the or each knot tying element it is possible to provide a dampening effect whereby the apparatus is less sensitive to pulling forces exerted by beginners than it is to pulling forces exerted by experienced surgeons. As a student improves the dampening effect can be reduced until the student is able to tie a knot without exerting undue pulling forces on the target area. The apparatus thus provides a staged and structured training system.

The force adjustment means may be a manual adjustment mechanism or it may be an electronic adjustment mechanism.

It is preferred that the sensing means generates a signal corresponding to the tension of the knot. This enables the second of the three key knot tying elements to be assessed. There are two aspects to consider in respect of the tension of the knot. Firstly, the tension of the knot must not exceed the maximum permissible for the particular purpose for which it is intended, as this can result in damage to the target area. Secondly, an appropriate minimum tension should be maintained throughout the process. In existing knot tying training products there is no means of assessing the tension of the knot. Consequently, the present invention offers a significant advantage over prior art training products.

The sensing means may also generate a signal corresponding to the strength of the knot. This is distinct from the tension of the knot as it relates to the quality of the knot and the likelihood of it slipping, or becoming loose, over time.

The knot tying training apparatus preferably comprises two knot tying elements, provided such that a knot may be tied around both of the knot tying elements. The knot tying elements are preferably in the form of prongs. The prongs may conveniently be provided with indents to identify the correct placement of the knot and to prevent slippage of the knot during the knot tying process. The advantage offered by having the knot tying elements in the form of prongs is that a tied knot can be slid off the prongs and subjected to visual inspection and further testing. Thus, the third of the key knot tying elements may be assessed.

The prongs are preferably movable towards and away from one another. When this is the case a knot may be tied around both of the elements. The tension of the knot will cause the prongs to move towards one another and the sensing means will determine the tension of the knot.

The feedback presentation unit preferably comprises a computer having a processor, a memory and a display means. The display means is preferably a graphical display. The memory may suitably be provided with information regarding the particular procedure being simulated, acceptable displacement and knot tension for the particular procedure and any other information as appropriate.

In order to encourage the user the feedback preferably comprises a rating for the knot tied around the or each knot tying element. The rating may suitably be based on the displacement of the or each knot tying element from the rest position. The rating may also be based on the tension of the knot. In this way the apparatus may be implemented in the form of a computer game. The difficulty level can be stepped up once the trainee has become confident at lower levels. This will hopefully create a healthy competition in an educational environment, giving trainees the best opportunity to succeed and hence learn.

The memory is preferably provided with a plurality of different difficulty levels corresponding to the force required to move the or each knot tying element from the rest position. The force required to move the or each knot tying element may be adjusted by the force adjustment means. The required force may be manually selected using a mechanical adjustment to correspond to the different difficulty levels stored in the memory. Alternatively, the required force may be electronically selected to correspond to the different difficulty levels stored in the memory. In this manner the apparatus provides a staged and structured training system which can be used by users of all levels of experience and skill.

The memory is preferably also provided with a plurality of different difficulty levels corresponding to acceptable minimum and maximum tensions of the knot around the or each knot tying element. In the case where the knot tying elements are in the form of prongs, the apparatus may also be provided with means for altering the force required to move the prongs towards and away from one another. The adjustment means may be manual adjustment means or electronic adjustment means. In this manner the apparatus provides a staged and structured training system which can be used by users of all levels of experience and skill.

The knot tying training apparatus preferably further comprises shielding means such that a user is provided with restricted access to the or each knot tying element. Once the student has mastered the art of tying a knot the shielding means can be added to the apparatus to increase the difficulty. There are many instances in which knots must be tied in relatively inaccessible areas and the apparatus helps to teach this skill in addition to the basic knot tying skill.

The or each knot tying element may suitably comprise a simulated anatomical structure. For example, these may be in the form of a simulated organ, a simulated epidermis, a simulated vessel or any other anatomical structure which may require suturing or ligating. The apparatus may suitably be provided with interchangeable knot tying elements which represent varying tissue thickness and strength.

### BRIEF DESCRIPTION OF THE DRAWINGS

For a better understanding of the present invention, reference will now be made to the accompanying drawing, in which:

FIG. 1 shows a schematic representation of a knot tying training apparatus.

### DESCRIPTION OF THE PREFERRED EMBODIMENT

The knot tying training apparatus 2 comprises two knot tying elements in the form of a pair of prongs 4a, 4b. In an alternative embodiment the apparatus may comprise a single knot tying element which may be in the form of a single prong or ring. The prongs 4a, 4b are substantially parallel along at least a part of their length and the free ends are movable towards and away from one another. The ends of the prongs 4a, 4b opposite the free ends are attached to a body member 6. The body member 6 is connected to a support stand 8 at a fixed pivot point P. The prongs 4a, 4b and the body member 6 are pivotable about the point P under the influence of forces applied during the process of tying a knot around the prongs 4a, 4b. The prongs 4a, 4b and the body member 6 are free to rotate about their x, y and z (into page) axes. The apparatus 2 is predominantly configured to monitor rotation about the y and z axes. Rotation about the x axis can generally be tolerated.

Sensing means 10 is provided at the free end of the body member 6. The sensing means 10 comprises a ferrite ring magnet 12 and a magnetic sensor 14. Displacement of the prongs 4a, 4b from a predetermined rest position of a knot, causes the ring magnet 12 to move. This movement is detected by the magnetic sensor 14 and a signal is generated. Consequently, any rotation of the apparatus about its axes will be detected by the sensing means 10. Other forms of sensing means may also be utilised, such as a photo emitter and receiver or any other means which will generate a signal in response to the rotation of the apparatus about its axes.

Further sensing means 16 is provided to measure the tension of a knot tied around the prongs 4a, 4b. The further sensing means 16 comprises a photo emitter 18 and a photo receiver 20 which measure the gap between the prongs 4a, 4b and generate a signal which is then converted by the further sensing means 16 into a signal corresponding to the tension of the knot tied around the prongs 4a, 4b. The tighter the knot the closer together the prongs 4a, 4b. Other forms of sensing means may also be utilised to measure the tension of the knot tied around the prongs 4a, 4b. For example, the sensing means may be in the form of a force measurement device connected to the prongs 4a, 4b which generates a signal in direct response to the tension of the knot tied around the prongs 4a, 4b. In an alternative embodiment the knot tying element may be a fluid filled element. The sensing means could then be configured to detect an increase of pressure in the knot tying element as a knot was tied.

The sensing means 10, 16 are connected to a feedback presentation means 22 in the form of a computer system with a processor, a memory and a display. The signals generated by the sensing means 10, 16 are fed into the feedback presentation means 22, which in turn provides a user with feedback regarding the quality of the knot tied around the prongs 4a, 4b. The feedback relates to the tension of the knot and to the displacement of the prongs 4a, 4b from a predetermined rest position.

The feedback presentation unit 22 has a display screen (not shown) which provides information regarding the quality of the knot. The feedback presentation unit 22 can provide visual information on whether the user has successfully tied the knot around the prongs 4a, 4b without excessive displacement and with the correct tension appropriate to the procedure. Alternatively, the feedback display unit 22 may provide other types of feedback, for example, auditory, tactile or some other indication.

The processor may suitably be configured to provide feedback on a specific procedure. The sensing means 10, 16 may be set up for a number of different procedures and the processor will interpret the signals form the sensors depending on the procedure.

The processor may also include comparative data corresponding to a correctly performed procedure. This enables the performance of a user to be compared to a consistent reference point and enables feedback to be provided whilst the knot tying procedure is being performed.

The signals generated by the sensing means 10, 16 are fed to the feedback presentation means 22 via cables 24, 26. Alternatively, blue tooth or any other transmitting system may be used to send the signal to the feedback means 22. The feedback presentation means 22 may be controlled and monitored using suitable software installed on the computer system.

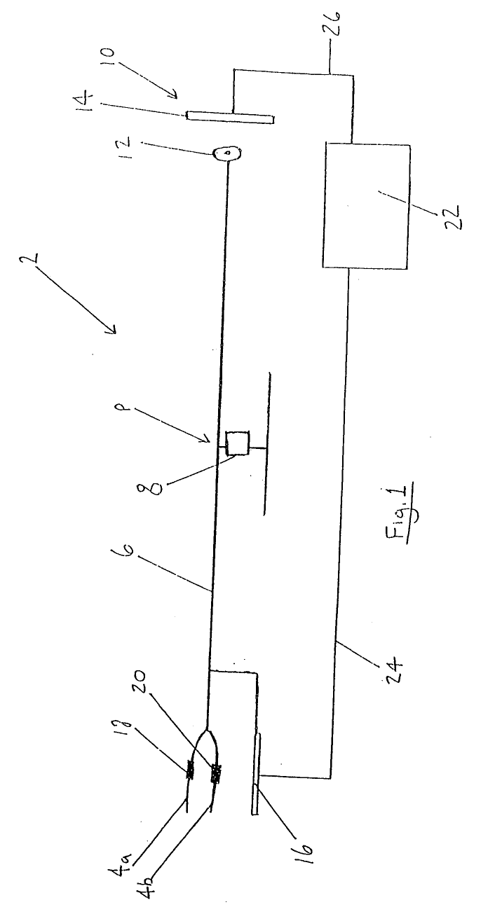

The operation of the knot tying training apparatus 2 will now be described with reference to FIG. 1. Firstly, a user selects the appropriate difficulty level from the computer system. The various difficulty levels available correspond to the resistance to rotation of the body member 6 about the pivot point P and the resistance to movement of the prongs 4a, 4b. The difficulty levels may be adjusted electronically or they may indicate calibrated settings to which the user may or must manually set the apparatus 2. In addition, each difficulty level is provided with acceptable maximum and minimum knot tension. The variety of different skill levels enables the apparatus 2 to be used by the students and surgeons alike and provides a staged and structured training system. Once a student has mastered one level the difficulty can be increased and the procedure repeated.

The user then proceeds to tie a knot around both of the prongs 4a, 4b. The prongs 4a, 4b may be provided with indents, near their free ends, in the area in which the knot is to be tied. This prevents the knot from slipping as it is tied. The sensing means 10 generates a signal, which corresponds to the displacement of the prongs 4a,4b from a rest position, in response to the movement of the ring magnet 12. A further signal is generated by the further sensing means 16 in response to the tension of the knot. As the knot is tied the prongs 4a, 4b are brought closer together and this is detected by photo emitter 18 and photo receiver 20.

The signals generated by the sensing means 10, 16 are fed into the feedback presentation means 22 which provides feedback to the user on the quality of the procedure. The feedback may also be provided during the procedure. For example, an alarm may sound during the procedure to indicate that excessive displacement has occurred or that excessive force has been used. In addition, the feedback may be provided in the form of a graphical representation of the knot tying procedure, indicating the various forces exerted during the knot tying process.

Once the user has successfully completed the chosen difficulty level they may then progress to the next difficulty level. As the user progresses through the levels the dampening effect of the force adjustment means is progressively decreased. Consequently, the force required to rotate the prongs 4a, 4b about the pivot point P is decreased. In addition, the acceptable maximum and minimum knot tensions are also altered to provide a more accurate simulation of the actual procedure. In this way the apparatus provides a staged and structured training method.

What is claimed is:

1. A knot tying training apparatus comprising:
at least one knot tying element around which a knot may be tied in use of the apparatus;
sensing means associated with the or each knot tying element for generating a signal in response to a knot being tied around the or each knot tying element; and
feedback presentation means in communication with the sensing means for providing feedback to a user.

2. A knot tying training apparatus according to claim 1, wherein the or each knot tying element is movable about a fixed point.

3. A knot tying training apparatus according to claim 2, wherein the or each knot tying element is rotatable about the fixed point.

4. A knot tying training apparatus according to claim 2, wherein the sensing means generates a signal corresponding to the displacement of the or each knot tying element from a rest position.

5. A knot tying training apparatus according to claim 2, wherein force adjustment means are provided for adjusting the force required to move the or each knot tying element.

6. A knot tying training apparatus according to claim 5, wherein the force adjustment means is manually operated.

7. A knot tying training apparatus according to claim 5, wherein the force adjustment means is electronically operated.

8. A knot tying training apparatus according to claim 1, wherein the sensing means generates a signal corresponding to the tension of the knot.

9. A knot tying training apparatus according to claim 1, wherein the sensing means generates a signal corresponding to the strength of the knot.

10. A knot tying training apparatus according to claim 1, comprising two knot tying elements, provided such that a knot may be tied around both of the knot tying elements.

11. A knot tying training apparatus according to claim 10, wherein the knot tying elements are in the form of prongs.

12. A knot tying training apparatus according to claim 11, wherein the prongs are movable towards and away from one another.

13. A knot tying training apparatus according to claim 11, wherein the prongs are provided with indents around which the knot may be tied.

14. A knot tying training apparatus according to claim 1, wherein the feedback presentation unit comprises a computer having a processor, a memory and a display means.

15. A knot tying training apparatus according to claim 14, wherein the display means is a graphical display.

16. A knot tying training apparatus according to claim 14, wherein the feedback comprises a rating for the knot tied around the or each knot tying element.

17. A knot tying training apparatus according to claim 16, wherein the rating is based on the displacement of the or each knot tying element from the rest position.

18. A knot tying training apparatus according to claim 16, wherein the rating is based on the tension of the knot.

19. A knot tying training apparatus according to claim 16, wherein the rating is based on the strength of the knot.

20. A knot tying training apparatus according to claim 14, wherein the memory is provided with a plurality of different difficulty levels corresponding to the force required to move the or each knot tying element from a rest position.

21. A knot tying training apparatus according to claim 14, wherein the memory is provided with a plurality of different difficulty levels corresponding to acceptable minimum and maximum tensions of the knot around the or each knot tying element.

22. A knot tying training apparatus according to claim 1, further comprising shielding means such that a user is provided with restricted access to the or each knot tying element.

23. A knot tying training apparatus according to claim 1, wherein the or each knot tying training element comprises a simulated anatomical structure.

24. A knot tying training apparatus according to claim 23, wherein the simulated anatomical structure is a simulated organ.

25. A knot tying training apparatus according to claim 24, wherein the organ is an epidermis.

26. A knot tying training apparatus according to claim 23, wherein the simulated anatomical structure is a vessel.
